(19) United States
(12) Patent Application Publication
(10) Pub. No.: US 2005/0156952 A1
(43) Pub. Date: Jul. 21, 2005

(54) Interactive display systems

(76) Inventors: Edward E. Orner, Atlanta, GA (US); Michael H. Dunn, Dunwoody, GA (US); Ian G. Hutchinson, Suwanee, GA (US); Peter W. Hildebrandt, Duluth, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/761,152

(22) Filed: Jan. 20, 2004

(51) Int. Cl. G09G 5/00

(52) U.S. Cl. 345/905

(57) ABSTRACT

An interactive display system is provided including a support frame having a vertical positioning element that counterbalances the weight of an attached interactive display, for example a touch-sensitive display. The support frame optionally includes a power supply increasing the range of mobility of the interactive display system by eliminating the need for power cord and power outlet connections. One exemplary support frame for an interactive display includes a base element, at least one support extending vertically from the base element, and a positioning element housed within the at least one support. The positioning element counterbalances the weight of the interactive display allowing vertical repositioning of the interactive display with a force of less than about 25 pounds.

### TECHNICAL FIELD

The present disclosure is generally related to interactive display systems and, more particularly, is related to touch-sensitive systems.

### BACKGROUND

Interactive electronic whiteboard systems, for example touch-sensitive systems, are popular communication tools frequently used in classroom settings as well as in business meetings. Commercially available interactive electronic whiteboard systems include the Webster™ Touch Sensitive and Walk-and-Talk™ systems available from PolyVision Corporation. This exemplary system generally includes a computer connected to a touch sensitive display and a projector. Data typically displayed on the computer's monitor can be projected onto the touch sensitive whiteboard. A user touches the touch sensitive whiteboard to interact with the projected data and control the presentation of the data, for example by controlling a software application being executed on the computer. The touch sensitive whiteboard operates as a dynamic user interface for the associated computer allowing the user to interact directly with displayed data and to publish the interaction to other computers networked with the interactive whiteboard system. Data that is written on the surface of the touch sensitive display can be incorporated into the projected data, and all of the data can be electronically captured, stored, or manipulated. As a result, a user in one location can provide an interactive presentation to local and remote audiences.

The touch sensitive whiteboard of commercially available interactive whiteboard systems is generally mounted onto a wall surface in close proximity to a power outlet needed to provide power to the display. In some interactive whiteboard systems, for example the Walk-and-Talk™ systems also available from PolyVision Corporation, the touch sensitive display may be mounted to the wall surface on a slidable track system. The slidable track system also provides power to the display so that the display can be moved, for example horizontally along the wall. Unfortunately, movement of the touch sensitive display is limited by the requirement for a power outlet.

Other interactive whiteboard systems include a whiteboard mounted on a movable stand. See for example U.S. Pat. No. 5,903,252 to Ogata. Generally, the display is mounted on a stand having wheels so that the whiteboard can be moved within a room. Adjusting the height of the display is difficult due in part to the weight of the display and typically requires two individuals. In addition, a lengthy power cord and connection cables are required to position the display away from a power outlet. Moreover, the additional power cord length can obstruct the user's movement during a presentation.

Thus, there is a need for mobile interactive electronic systems.

There is another need for self-powered interactive electronic systems.

There is still another need for an electronic whiteboard apparatus for facilitating cordless repositioning.

### SUMMARY OF THE DISCLOSURE

Embodiments of the present invention provide interactive display systems, including, but not limited to touch-sensitive display systems. Briefly described, one embodiment of the present disclosure, among others, provides a mobile interactive display system. The interactive display system can include an electronic whiteboard, for example a touch-sensitive electronic whiteboard. In some embodiments, the disclosed interactive display systems have an increased range of mobility due in part to the self-powered support stand. By incorporating a self-contained power supply into the interactive display system, the mobility of the system is no longer limited to the length of a power cord or the location of a power outlet. Accordingly, embodiments of the present disclosure provide interactive display systems that can be moved about a room virtually without limitation. Exemplary systems of the present disclosure include but are not limited to an interactive display, for example a touch sensitive display, mounted on a support frame, for example a mobile support frame, having at least one vertical positioning element. The system can optionally include the following: a computer operably connected to the interactive display, a projector, a stylus and/or an eraser.

Another embodiment of the present disclosure provides an adjustable and mobile support frame for an interactive display. An exemplary support frame includes a base element and at least one support extending vertically from the base element. The support can be configured to receive an interactive display, and the support frame can optionally include a power supply, for example a rechargeable power supply. The power supply can be attached to the support frame or housed within an element of the support frame. The mobility of the support frame can be facilitated by attaching wheels, rollers, castors, treads or the like to the base element.

In still another embodiment, the vertical position of the interactive display can be adjusted using at least one vertical positioning element of the support frame. The vertical positioning element includes but is not limited to hydraulic or pneumatic devices such as pistons and gas springs. The vertical positioning element can provide a counterbalancing force to the weight of the touch-sensitive display on the support frame so that the vertical position of the touch-sensitive display can be adjusted by applying less than about 25 pounds of force, preferably about 1.0 ounce to about 3 pounds of force. In another embodiment, a user can adjust the height of the touch-sensitive display using finger pressure.

Yet another embodiment provides a self-powered, mobile interactive display system including for example, an electronic whiteboard. Embodiments of the disclosed interactive display systems can be in wireless communication with one or more computers, and the interactive displays can be mounted onto a vertically adjustable support frame. An integrated or peripheral power supply of the support frame can power the interactive display. For example, an interactive electronic whiteboard system can be moved without the limitations of a power cord or proximity to a power outlet.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1A is a front view of an exemplary interactive display system.

FIG. 1B is representation of another exemplary interactive display system.

FIG. 2 is a diagram of an exemplary support frame.

FIG. 3A is a representation of an exemplary positioning element.

FIG. 3B is a representation of an upper portion of the exemplary positioning element shown in FIG. 3A.

FIG. 3C is a representation of a center portion of the exemplary positioning element shown in FIG. 3A.

FIG. 4A is a representation of an exemplary embodiment including a power supply as seen from the front.

FIG. 4B is a representation of an exemplary embodiment including a power supply as seen from the behind.

FIG. 5 is a diagram of an alternative embodiment of the disclosed support frame.

FIG. 6 is a diagram of another embodiment of the disclosed support frame.

FIG. 7 is a diagram of still another embodiment of the disclosed support frame.

### DETAILED DESCRIPTION OF THE EMBODIMENTS

Embodiments of the present disclosure are generally directed to interactive display systems 110 including interactive electronic whiteboard systems, for example touch-sensitive electronic whiteboard systems. Suitable interactive displays include touch-sensitive electronic whiteboards 112, rear-projection displays, laser tracking displays, sonic tracking displays, optical capture displays, televisions, plasma screen displays, LCDs, and eInk displays which use oil-filled capsules in which particles of titanium dioxide are suspended. eInk displays use an electrical charge conferred to selected particles (which are white) to create an image.

1. Mobile Interactive Display Systems with Vertical Adjustment Means

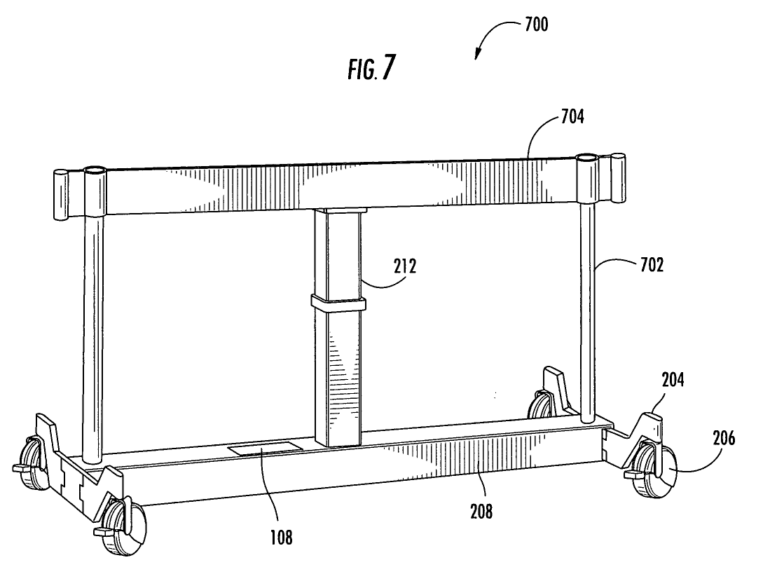

One of the several embodiments described herein includes an interactive display 112, for example an electronic whiteboard in combination with a support frame 200, for example a mobile support frame. Support frame 200 includes mobile elements 206 such as wheels, treads, or rollers for facilitating repositioning of the interactive display system, but it will be appreciated that any means for reducing friction between the support stand and a floor surface can be utilized. Exemplary support frames include at least one vertical positioning element 212, for example a hydraulic or pneumatic device including, but not limited to, gas springs or pistons. The positioning element 212 can be housed within a channel or recess 203 of support 202. In one embodiment, positioning element 212 can be a gas spring encased in an extruded channel 203 of vertical support 202. Encasing positioning element 212 within an extruded channel avoids the need for additional fasteners for securing positioning element 212 to support 202. Alternatively, the positioning element 212 can itself be a vertical support 202 as shown in FIG. 7.

Generally, the positioning device 212 can be calibrated to counterbalance the weight of an interactive display 112, for example, a touch-sensitive display, mounted to the support frame 200. By counterbalancing the weight of the attached interactive display panel 112, the vertical position of the display 112 can be adjusted by applying less than about 25 pounds of force, preferably about 1.0 ounce to about 3 pounds of force, for example, finger pressure. Once the display 112 is placed at a desired distance from the floor, the display 112 can be locked in place, for example by tightening knob 214 which secures the positioning element in place.

2. Self-Powered Interactive Display System

Another embodiment of the present disclosure provides a cordless and mobile interactive display system. The term “cordless” means self-powered, for example, not requiring a power cord connected to a power outlet. The cordless interactive display system can include an interactive display, for example, an electronic whiteboard 112, mounted on a mobile support frame 200. The mobile support frame 200 includes a power source or power supply 108, for example a rechargeable power supply. The self-powered mobile support frame enables the interactive electronic whiteboard to be positioned in a room or space without limitation by the length of a power cord or the position of a power outlet, for example a power outlet in a wall.

3. Self-Powered Interactive Display System with Vertical Adjustment Means

Still another embodiment provides a interactive display system including an interactive display 112 mounted to a self-powered, mobile support frame 200 wherein the support frame can be vertically positioned by actuating at least one vertical positioning element 212, for example a hydraulic or pneumatic device including but not limited to gas springs or pistons. The positioning element 212 can be housed within a vertical support 200, for example within a channel or recess. Alternatively, the positioning element 212 can itself be a vertical support as shown in FIG. 7. Generally, the positioning device 212 can be calibrated to counterbalance the weight of an interactive display, for example a touch-sensitive display, mounted to the support frame 200. By counterbalancing the weight of the attached interactive display panel 112, the vertical position of the display 112 can be adjusted by applying less than about 25 pounds of force, preferably about 1.0 ounce to about 3 pounds of force, for example, finger pressure. Once the display 112 is placed at a desired distance from the floor, the display 112 can be locked in place, for example by tightening knob 214 which secures the positioning element in place.

4. Interactive Display Systems with a Communication Means

It will be appreciated that any of the disclosed embodiments described herein can optionally include communication device 122. For example, one interactive display system 30 includes an interactive display 112 such as an electronic whiteboard mounted on a mobile stand 200, wherein the mobile stand 200 includes a vertical positioning element 212. The vertical positioning element 212 includes for example, a pneumatic or hydraulic piston such as gas springs. The system further includes communication device 122. Communication device 122 includes, but is not limited to, a wireless communication device.

In still another embodiment, a mobile, self-powered interactive display system as described herein can include communication device 122. In this embodiment, the interactive display 112 is mounted on a mobile support frame 200. Yet another embodiment provides a mobile display system including an interactive display 112 mounted on a mobile support frame 200 having at least one vertical positioning element 212, a communication device 122, and a power source 108, for example a rechargeable power source including, but not limited to, standard alkaline batteries.

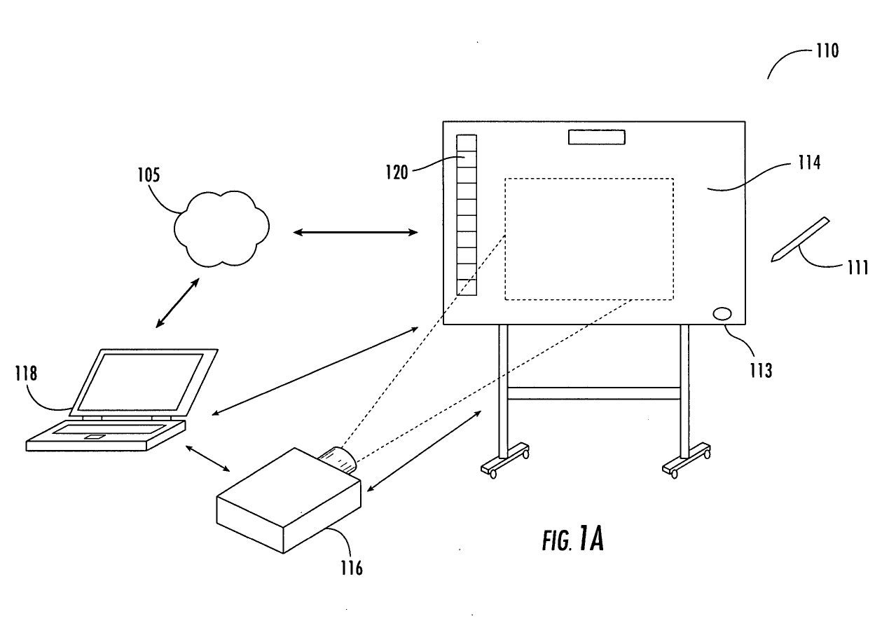

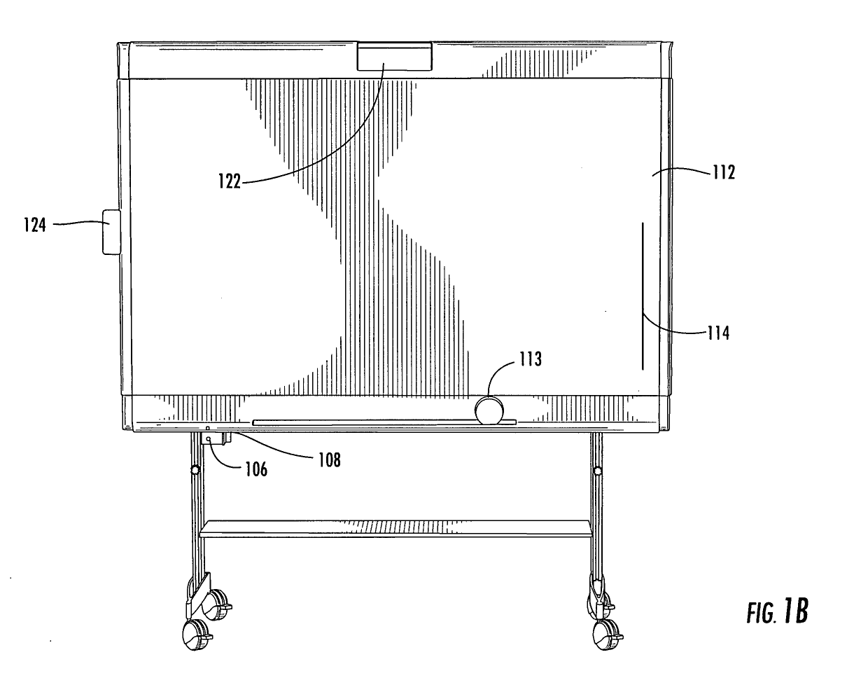

Turning now to the Figures, FIGS. 1A and 1B depict exemplary interactive display system 110 having communication device 122, for example a wireless communication device, for receiving or transmitting data. In one embodiment, a user can use a remote control device to actuate a function of the interactive display system 110 including controlling an operating system by wirelessly transmitting data to communication device 122. In another embodiment, communication device 122 can transmit coordinate data to processing device 118, for example via wireless transmission. The remote control device can be conveniently stored on bracket 124. Communication device 122 includes infrared transceivers, radio wave transceivers, telephony devices and the like. The interactive display system 110 can communicate with a distributed computer network 105, for example a local area network, wide area network, or the Worldwide Web, using standard protocols including but not limited to any type of radio frequency (802.11 network, whether 802.11b, 802.11a, dual-band, etc.) infrared, or other means.

The exemplary interactive display system 110, FIGS. 1A and 1B, optionally includes: a projector 116 for projecting data onto a display surface 114, a computing device 118, a stylus 111, and/or an eraser 113. Processing device 118 can be an integrated component of the electronic whiteboard 112, or processing device 118 can be an external component, for example a processing device capable of running electronic whiteboard operating systems, drivers, software or specific application software including an ordered listing of executable instructions for implementing logical functions. Such instructions can be utilized in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory. In addition, the scope of an embodiment of the present invention includes embodying the functionality of the preferred embodiments of the present invention in logic embodied in hardware or software-configured mediums.

Interactive displays, for example electronic whiteboards 112 are known in the art and can receive input from a user in a variety of ways. For example, electronic whiteboards 112 can incorporate capacitance technology and receive input from a user via an electrically conductive stylus. The stylus 111 can be a writing implement including a finger. An exemplary stylus 111 can transmit a signal to electronic whiteboard 112 indicating the location of the stylus 111 in relation to a surface of the electronic whiteboard. The stylus 111 can also transmit other information to electronic whiteboard 112 including but not limited to pen color, draw or erase mode, line width, font or other formatting information.

In another embodiment, electronic whiteboard 112 can include a touch sensitive or pressure sensitive surface 114 for receiving input. Touch sensitive or pressure sensitive means having the capability to convert a physical contact into an electrical signal or input. Touch sensitive electronic whiteboards can incorporate resistive membrane technology. See for example U.S. Pat. No. 5,790,114 to Geaghan et al. describing resistive membrane electronic whiteboards and which is incorporated herein in its entirety.

Briefly, electronic whiteboard 112 can have two conductive sheets physically separated from one another, for example by tension or a deformable conductive foam, such that the two sheets contact each other in response to a touch or physical pressure. The sheets can be made of a conductive material or can be coated with a conductive material such as a conductive film, and can themselves be deformable. Touching, writing, or other application of pressure on the surface of the conductive sheets causes contact between the two conductive sheets resulting in a detectable change in voltage or resistance. The sheets can act as resistance dividers and a voltage gradient can be created by applying different voltages at the edges of a sheet. The change in voltage or resistance can then be correlated to a location value, for example a Cartesian coordinate set. Coordinate data, for example (x,y) pairs or their equivalent can be transmitted to processing device 118, for example in compatible data packets.

The location information can be transmitted or relayed to processing device 118, such as a personal computer, for processing, manipulating, editing, or storing. Conventional dry-erase markers are typically used to write on a surface 114 of electronic whiteboard 112, but any erasable, removable ink, or permanent pigment, or coloring can be used to physically mark a surface 114 of electronic whiteboard 112. The physical markings on electronic whiteboard 112 can be removed using conventional methods including an eraser 113, towel, tissue, hand, or other object that physically removes the markings from the surface 114 of electronic whiteboard 112.

Electronic whiteboard 112 can also include a control area 120. Control area 120 can contain multiple control areas for controlling a function of the electronic whiteboard system 110. Control area 120 can be an actuator, for example a physical button, that can be actuated by applying pressure to the control area. The function of control area 120 can be fixed or variable. If the function of control area 120 is variable, control area 120 can comprise a soft key whose function can be controlled by processing device 118. For example, a soft key can have different functions depending on different application software running on processing device 118. An image or icon can be projected near control area 120 indicating the current function of a soft key using a projector 116.

Projector 116 can be operatively connected to electronic whiteboard 112 or processing device 118, or both. Projector 116 can be a conventional projecting device for projecting a graphical user interface typically on a display monitor of computing device 118 onto a surface 114 of the electronic whiteboard 112. Projector 116 can adjust for image distortions including keystoning and other optical problems, for example optical problems arising from the alignment of an image on projected on surface 114 with the graphical user interface on display. Alternatively, processing device 118 can adjust the image or correct alignment problems. A user can physically adjust projector 116 to compensate for image problems including keystoning.

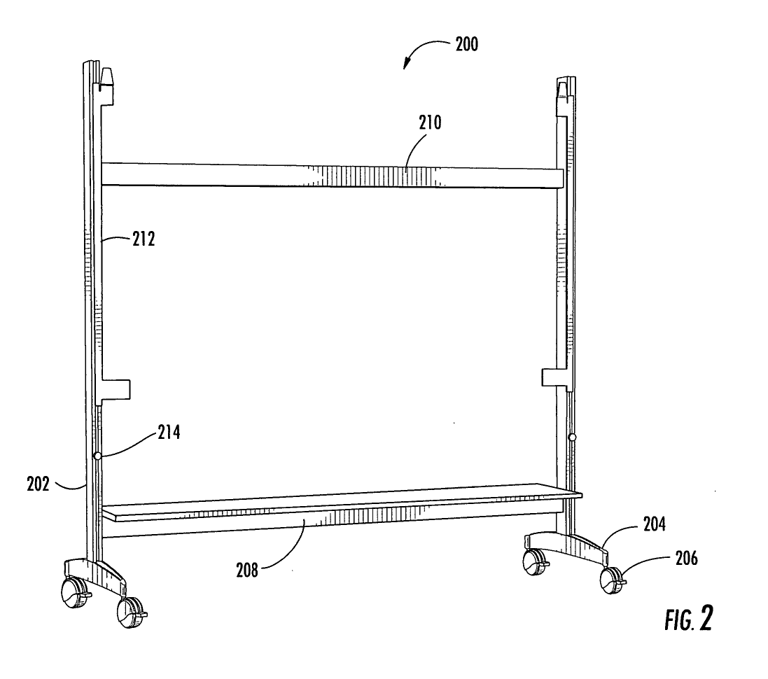

FIG. 2 is a diagram of an exemplary support frame 200 for the interactive display system 110. One embodiment of the support frame or stand 200 includes at least one vertical support 202, preferably two vertical supports 202. Vertical support 202 can be of a fixed length or have an adjustable length and is connected at the lower end to a base element 204. Base element 204 has a plurality of mobile elements 206 to facilitate the movement of interactive display system 110. Suitable mobile elements include, but are not limited to, wheels, castors, rollers, treads, and the like. Mobile elements 206 can be hingedly mounted onto base element 204 to allow each wheel to fold or swivel inward towards electronic whiteboard 112. Alternatively, base element 204 can be collapsible such that mobile elements 206 fold inward towards support 202.

Two or more vertical supports 202 can be connected by at least one horizontal support 210, 208. Lower horizontal support 208 can include a shelf element 209 having a planar surface substantially parallel to a floor surface. Additionally, lower support 208, shelf element 209, and base element 204, or a combination thereof can be weighted or manufactured with dense material to provide support frame 200 with a low center of gravity to help reduce tipping. In one embodiment, support frame 200 is weighted or manufactured such that support frame 200 can tip up to about 20 degrees, preferably 10 degrees from the vertical axis without falling over.

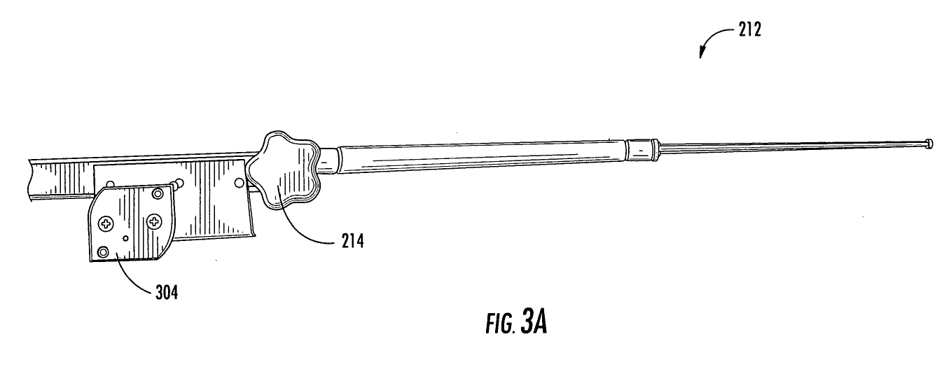

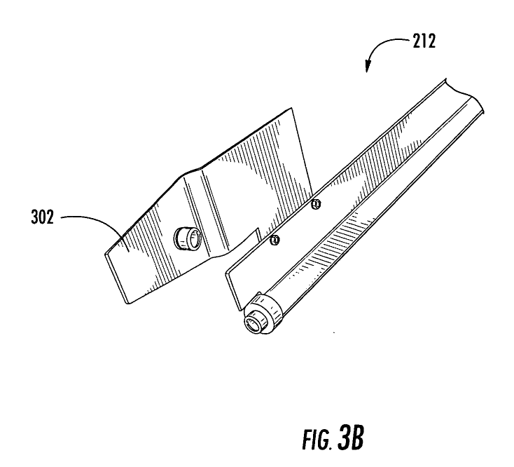

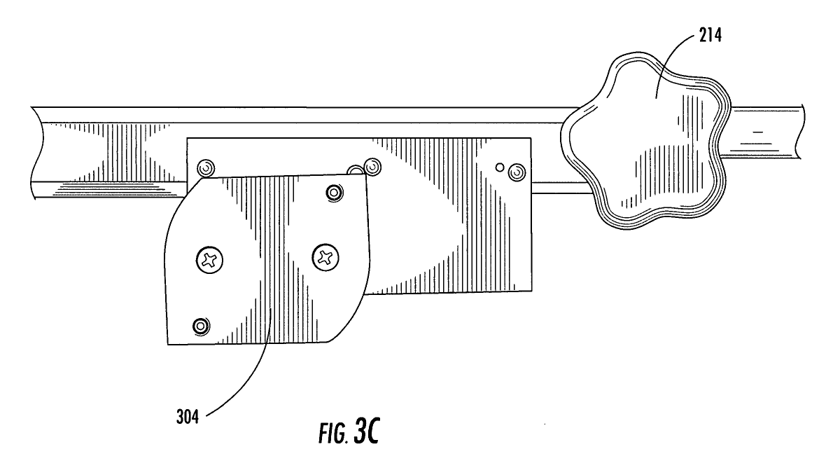

In another embodiment, vertical support 202 contains a hollow recess or channel for receiving and/or housing vertical positioning element 212. FIGS. 3A-C show an exemplary vertical position element 212 which can be a hydraulic or pneumatic device such as a piston or spring, for example a gas spring, that can extend or contract. Hydraulic and pneumatic pistons and gas springs are known in the art, and are commercially available (Service Plus Distributors, Inc. 1900 Frost Road, Suite 101 Bristol, Pa.). A gas spring can be a hydropneumatic adjusting element, consisting of a pressure tube, a piston rod with piston and appropriate connection fittings. It is generally filled with compressed inert gas such as nitrogen, which acts with equal pressure on differently dimensioned cross-sectional areas of the piston. This produces a force in the extension direction. This extension force can be exactly defined within physical limits through the appropriate selection of the filling pressure.

Accordingly, vertical positioning element 212 can be calibrated to compensate or counterbalance the weight of a mounted interactive display such as an electronic whiteboard 112 such that mounted electronic whiteboard 112 can be positioned vertically on the disclosed support frame 200 by applying minimal pressure, such as finger pressure. In one embodiment, the vertical positioning element 212 is calibrated to apply an upward force or lift to interactive display 112 to counterbalance the downward force caused by the weight of the interactive display 112, for example electronic whiteboard 112. One or a plurality of vertical positioning elements 212 supply enough force to counterbalance of weight of at least about 200 lbs., preferably at least about 100 lbs., even more preferably from about 50 lbs. to about 200 lbs. The amount of force supplied by vertical positioning element 212 can be adjusted to vary the height of the interactive display 112. In another embodiment, vertical positioning element or elements 212 apply sufficient counterbalancing force so that interactive display 112 can be vertically repositioned on the disclosed support frame by a single user applying finger pressure to interactive display 112. For example, a user can vertically adjust the position of an electronic whiteboard 112 by actuating vertical positioning element 212, for example releasing a positioning clamp or gas spring lock, and applying a force of less than about 25 pounds, preferably about 1.0 ounce to about 3 pounds of force to electronic whiteboard 112. Once electronic whiteboard 112 is in a desired position, the user can immobilize electronic whiteboard 112 by tightening fastener 214.

When support frame 200 includes more than one vertical support 202 each having a vertical positioning element 212, a single actuator, for example a pedal 502, button, or switch, can be used to simultaneously actuate the vertical positioning elements 212, for example to release a positioning clamp to allow the positioning element to extend. Such extension or contraction can be accomplished, for example, using telescoping elements. Alternatively, vertical positioning element 212 can itself function as vertical support 202.

At least one mounting bracket 302 is affixed to vertical positioning element 212. Mounting bracket 302 is typically secured to the upper end of positioning element 212. A lower mounting bracket 304 can optionally be used and is generally secured to the lower end of positioning element 212. Mounting brackets 302 and 304 are configured to receive interactive display 112. For example, electronic whiteboard 112 can include a recess for matingly engaging mounting brackets 302 or 304. Alternatively, one or more separate mounting brackets can be secured to the electronic whiteboard 112, and these separate mounting brackets can be secured to one or more upper mounting brackets 302. Mounting brackets 302 or 304 can be fastened directly to interactive display 112 or to a mounting bracket secured to interactive display 112 using conventional fasteners including but not limited to screws, nuts, bolts, clamps, pins, buckles, braces, and the like.

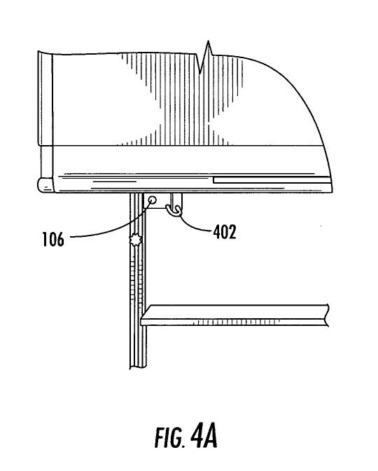

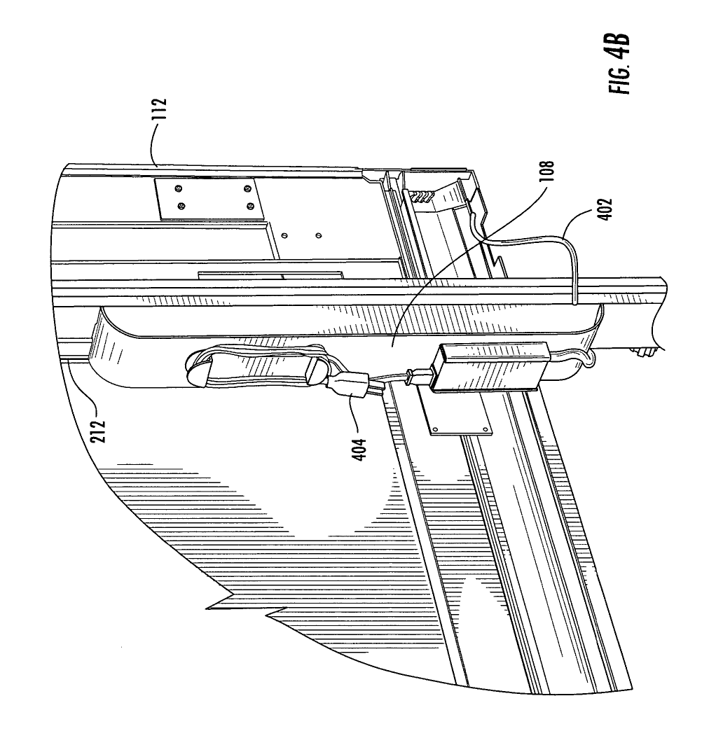

FIGS. 4A and 4B show another embodiment of support frame 200 having a power source or supply 108 as seen from the front and back respectively. Power source or supply 108 can include one or more power cells, including but not limited to standard “D” cell batteries. It will be appreciated by those of skill in the art that any suitable power source or cell can be used in conjunction with the disclosed including conventional batteries, or a rechargeable power source including, but not limited to, rechargeable batteries such as nickel metal hydride (NiMH) batteries. The rechargeable power source can optionally include a recharging element 403. Recharging elements are known in the art and are commercially available.

Alternatively, power supply 108 can include a fuel cell such as a hydrogen fuel cell. Suitable conventional batteries include alkaline batteries using an hydrous alkaline solution as an electrolyte. For example a manganese-dioxide primary cell with potassium hydroxide as an electrolyte can be used. During cell discharge, the oxygen-rich manganese dioxide is reduced and the zinc becomes oxidized while ions are being transported through the conductive alkaline electrolyte.

Power supply 108 includes standard power connections 402 for providing electrical power to interactive display system 110. Alternatively, interactive display system 110 can be in electrical communication with power supply 108 via support frame 200. In another embodiment, power supply 108 can be recharged via a connection 404 to a standard wall power outlet. It will be appreciated that power supply 108 can be in any geometric shape. One embodiment provides a power supply 108 having a projection on an outer surface for fitting into a channel or recess of vertical support 212. The width of power supply 108 can be conformed to the width of vertical support 212, and power supply 108 can be secured to vertical support 212 by inserting the projection into the channel of vertical support 212. Once fitted into position on vertical support 212, power supply 108 can be further secured using conventional fasteners.

Power supply 108 also includes a status indicator 106 for communicating stored power levels to a user. For example, power supply 108 can include a LED display 106 that can be color-coded to indicate the level of stored power. Power supply 108 can be positioned on or within support frame 200 such that the power level indicator 106 is visible when interactive display 112 is viewed from the front. For example, power supply 108 can be mounted onto or within vertical support 202 exposing the power level indicator 106 below the bottom edge of interactive display 112. In still another embodiment, power supply 108 can be housed within a vertical or horizontal support and a battery charge level indicator 106 can be displayed on the front of interactive display 112.

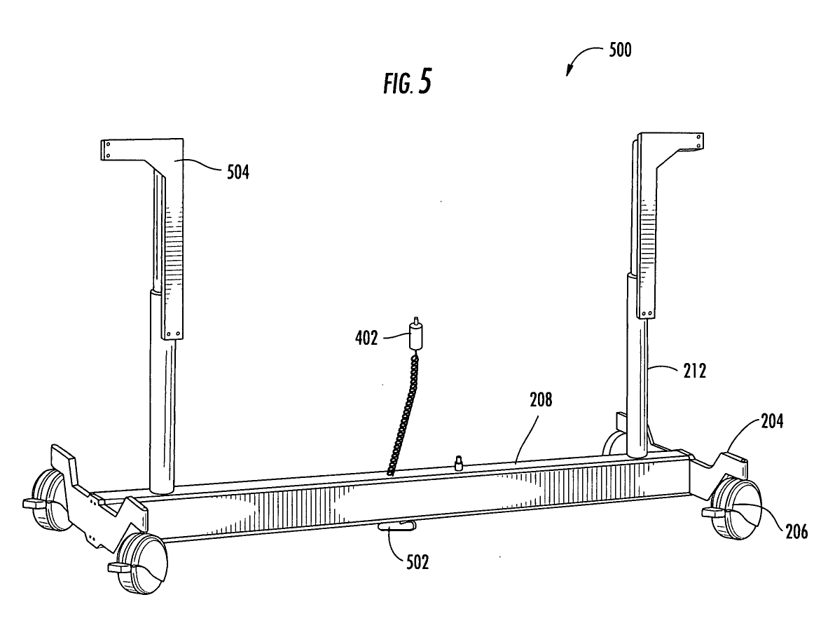

FIGS. 5 is a diagram of an exemplary support frame having a plurality of vertical positioning elements 212 which can be individually mounted to an interactive display, for example a touch-sensitive display such as an electronic whiteboard 112. Mounting brackets 504 are affixed to vertical positioning elements 212 to receive an interactive display, for example a touch-sensitive display. In this embodiment, vertical positioning elements 212 include hydraulic or pneumatic devices such as gas springs. Positioning elements 212 are calibrated to provide a counterbalancing force to the weight of the interactive display and can be actuated by pedal 502. Accordingly, positioning elements 212 are collectively or independently calibrated to counterbalance a weight of about 50 to about 200 lbs, preferably about 25 to about 75 lbs. Lower horizontal support 208 connects vertical positioning elements 212. Base elements 206 having a plurality of wheels, rollers, or castors 206 are mounted onto opposite ends of horizontal support 208 by substantially flat arms 204. A power supply 108 can be mounted within or on horizontal support 208 to power the touch-sensitive display.

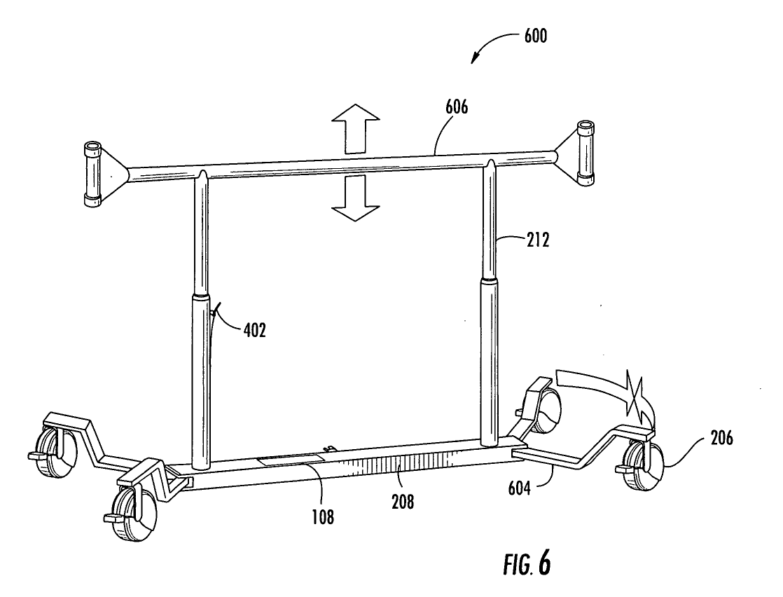

FIG. 6 is a diagram of an embodiment having adjustable roller arms 604. Support frame 600 includes a horizontal support 208 having a plurality of rollers 206 mounted on opposite ends of horizontal support 208. Rollers 206 are mounted to roller arms 604. Two roller arms 604 are mounted on either end of horizontal support 208 and pivot about the end of horizontal support 208 to adjust the distance between rollers 206. For example, two rollers 206 can be collapsed together towards horizontal base element 208 for storage. Preferably, each roller arm 604 can pivot so that the angle between two contiguous roller arms 604 ranges from about 0 to greater than about 180 degrees. Typically, the angle between roller arms 604 will be adjusted, for example increased to about 60 to about 180 degrees, to prevent tipping of stand 600. It will be appreciated that roller arms 604 can be locked in place when the desired degree of separation between rollers 206 is achieved. Support frame 600 also includes horizontal support 606 configured to receive electronic whiteboard 112. Horizontal support 606 connects vertical positioning elements 212.

Support stand 700 shown in FIG. 7 includes a single vertical positioning element 212 extending vertically from lower horizontal support 208 to upper horizontal support 704. Non-extendible vertical supports 702 provide a guide for upper horizontal support 704 by extending through openings on opposite ends of upper horizontal support 704. An interactive display including a touch-sensitive display such as electronic whiteboard 112 can be mounted on horizontal support 704. The vertical position of interactive display 112 can be adjusted by actuating vertical positioning element 212 for example by releasing a lock on vertical positioning element 212. Support stand 700 also includes roller arms 204 which are hingedly mounted to an end of horizontal support 208. Thus, rollers 206 can be folded inward towards horizontal support 208. Horizontal support 208 can also include power supply 108 therein.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. A support frame for an interactive display comprising:
a base element;
at least one support extending vertically from the base element; and
a positioning element housed within the at least one support, the positioning element configured to receive the interactive display, wherein the positioning element counterbalances the weight of the interactive display allowing vertical repositioning of the interactive display with a force of less than about 25 pounds.

2. The support frame of claim 1, wherein vertical repositioning force ranges from about 1.0 ounce to about 3 pounds.

3. The support frame of claim 1, further comprising a plurality of mobile elements mounted on the base element.

4. The support frame of claim 1, wherein the vertical positioning element comprises a hydraulic or pneumatic device.

5. The support frame of claim 4, wherein the hydraulic or pneumatic device comprises a gas spring.

6. The support frame of claim 1, further comprising an interactive display mounted thereon.

7. The support frame of claim 1, further comprising a plurality of vertical supports.

8. The support frame of claim 7, wherein at least one horizontal support connects at least two of the plurality of vertical supports.

9. The support frame of claim 6, wherein the interactive display is selected from the group consisting of an electronic whiteboard, a touch-sensitive display, rear-projection display, laser tracking display, sonic tracking display, optical capture display, television, plasma display, LCDs, and displays which use oil-filled capsules in which particles of titanium dioxide are suspended.

10. The support frame of claim 1, further comprising a power source secured to the support frame.

11. The support frame of claim 10, wherein the power source is rechargeable.

12. The support frame of claim 10, wherein the power source comprises a battery.

13. The support frame of claim 12, wherein the battery is rechargeable.

14. The support frame of claim 11, wherein the power source includes a recharger.

15. The support frame of claim 10, wherein the power source includes a power cord for recharging.

16. The support frame of claim 10, wherein the power supply includes a power level indicator.

17. The support frame of claim 16, wherein the power level indicator is positioned to be viewed from the front of the support frame.

18. A support frame for an interactive display comprising:
a base element;
a support extending vertically from the base element configured to receive an interactive display; and
a power source affixed to the support frame for powering the interactive display.

19. The support frame of claim 18, further comprising a plurality of mobile elements mounted on the base element.

20. The support frame of claim 18, wherein the support comprises a vertical positioning element.

21. The support frame of claim 20, wherein the vertical positioning element provides sufficient force to counterbalance the weight of the interactive display.

22. The support frame of claim 21, wherein a vertical force of less than about 25 pounds repositions the interactive display.

23. The support frame of claim 21, wherein a vertical force of about 1.0 ounce to about 3 pounds repositions the interactive display.

24. The support frame of claim 21, wherein the vertical positioning element comprises a hydraulic or pneumatic device.

25. The support frame of claim 18, further comprising an interactive display.

26. The support frame of claim 18, further comprising a plurality of vertical supports.

27. The support frame of claim 26, wherein at least one horizontal support connects at least two of the plurality of vertical supports.

28. The support frame of claim 18, wherein the power source is rechargeable.

29. The support frame of claim 18, wherein the power source comprises a battery.

30. The support frame of claim 29, wherein the battery is rechargeable.

31. The support frame of claim 18, wherein the power source includes a recharger.

32. The support frame of claim 18, wherein the power source includes a power cord for recharging.

33. The support frame of claim 25, wherein the interactive display is selected from the group consisting of an electronic whiteboard, a touch-sensitive display, rear-projection display, laser tracking display, sonic tracking display, optical capture display, televisions, plasma display, LCDs, and displays which use oil-filled capsules in which particles of titanium dioxide are suspended.

34. An interactive display system comprising:
an interactive display mounted onto a support frame, the support frame comprising:
a base;
a positioning element extending vertically from the base configured to receive the interactive display; and
a power source affixed to the base or support for powering the interactive display.

35. The interactive display system of claim 34, further comprising a plurality of mobile elements mounted on the base.

36. The interactive display system of claim 34, wherein the positioning element provides sufficient force to counterbalance the weight of the interactive display and allow vertical repositioning of the interactive display.

37. The interactive display system of claim 36, wherein the interactive display is repositioned with less than about 25 pounds of force.

38. The interactive display system of claim 36, wherein the interactive display is repositioned with about 1.0 ounces to about 3 pounds of force.

39. The interactive display of claim 34, wherein the positioning element comprises a hydraulic or pneumatic piston.

40. The interactive display of claim 34, wherein the interactive display is selected from the group consisting of an electronic whiteboard, a touch-sensitive display, rear-projection display, laser tracking display, sonic tracking display, optical capture display, televisions, plasma display, LCDs, and displays which use oil-filled capsules in which particles of titanium dioxide are suspended.

41. The interactive display system of claim 34, further comprising a projector for projecting an image onto a surface of the interactive display.

42. The interactive display system of claim 41, wherein the surface is a touch-sensitive surface.

43. The interactive display system of claim 34, further comprising a computer in communication with the interactive display.

44. The interactive display system of claim 34, wherein the power source is rechargeable.

45. The interactive display system of claim 34, wherein the power source comprises a battery.

46. The interactive display system of claim 45, wherein the battery is rechargeable.

47. The interactive display system of claim 34, wherein the power source includes a recharger.

48. The interactive display system of claim 34, wherein the power source includes a power cord for recharging.

49. A support frame for a interactive display comprising:
a base having positionable first and second arms;
mobile elements mounted to the first and second arms; and
a vertically adjustable support extending from the base configured to receive an interactive display.

50. The support frame of claim 49, wherein the first and second arms of the base element collapse towards the support.

51. The support frame of claim 49, further comprising a power source mounted to the support frame.

52. The support frame of claim 51, wherein the power source is rechargeable.

53. The support frame of claim 51, wherein the power source comprises a battery.

54. The support frame of claim 53, wherein the battery is rechargeable.

55. The support frame of claim 51, wherein the power source includes a recharger.

56. The support frame of claim 51, wherein the power source includes a power cord for recharging.

57. The support frame of claim 49, wherein the vertically adjustable support provides sufficient force to counterbalance the weight of the interactive display and allow repositioning of the interactive display.

58. The support frame of claim 57, wherein interactive display is repositioned with less than about 25 pounds of force.

59. The support frame of claim 57, wherein the interactive display is repositioned with about 1.0 ounce to about 3 pounds of force.

60. The support frame of claim 49, wherein the adjustable vertical support comprises a hydraulic or pneumatic piston.

61. The support frame of claim 49, wherein the interactive display is selected from the group consisting of an electronic whiteboard, a touch-sensitive display, rear-projection display, laser tracking display, sonic tracking display, optical capture display, televisions, plasma display, LCDs, and displays which use oil-filled capsules in which particles of titanium dioxide are suspended.

62. An electronic whiteboard system comprising:
a electronic whiteboard having a wireless communication device, wherein the electronic whiteboard is mounted on a mobile support frame, the mobile support frame comprising:
a wheeled base element; and
a pneumatic or hydraulic positioning element extending vertically from the base element configured to receive the electronic whiteboard and provide sufficient force to counterbalance the weight of the electronic whiteboard to maintain the electronic whiteboard at a desired vertical position.

63. The electronic whiteboard system of claim 62, further comprising a power source affixed to the support frame for powering the electronic whiteboard.

64. The electronic whiteboard system of claim 63, wherein the power source is rechargeable.

65. The electronic whiteboard system of claim 63, wherein the power source comprises a battery.

66. The electronic whiteboard system of claim 65, wherein the battery is rechargeable.

67. The electronic whiteboard system of claim 63, wherein the power source includes a recharger.

68. The electronic whiteboard system of claim 62, further comprising a projector for projecting an image on a touch-sensitive surface of the electronic whiteboard.

69. The electronic whiteboard system of claim 62, wherein the positioning element is housed within a vertical support.

70. A support stand comprising:
a base element;
at least one support extending vertically from the base element; and a positioning means configured to receive an interactive display, wherein the positioning means counterbalances the weight of the interactive display allowing vertical repositioning of the touch-sensitive display with a force of less than about 25 pounds.

71. The support stand of claim 70, wherein the interactive display is selected from the group consisting of an electronic whiteboard, a touch-sensitive display, rear-projection display, laser tracking display, sonic tracking display, optical capture display, televisions, plasma display, LCDs, and displays which use oil-filled capsules in which particles of titanium dioxide are suspended.

72. The support stand of claim 70, further comprising a rechargeable means for supplying power to the interactive display.
